(19) United States
(12) Patent Application Publication
(10) Pub. No.: US 2012/0011959 A1
(43) Pub. Date: Jan. 19, 2012

(54) AUTO LOCK MECHANISM OF CLOCK SPRING FOR VEHICLE

(75) Inventors: Min Ha Park, Gwangmyeong (KR); Sung Ik Yim, Anyang (KR); Seung Kyu Yang, Suwon (KR)

(73) Assignees: KIA MOTORS CORPORATION, Seoul (KR); HYUNDAI MOTOR COMPANY, Seoul (KR)

(21) Appl. No.: 12/948,590

(22) Filed: Nov. 17, 2010

(30) Foreign Application Priority Data
Jul. 14, 2010 (KR) 10-2010-0068176

(51) Int. Cl. G05G 5/06

(52) U.S. Cl. 74/527

(57) ABSTRACT

An auto lock mechanism of a clock spring for a vehicle is provided. The auto lock mechanism comprises a rolling plate provided in an internal space of the clock spring such that the rolling plate is rotated by a flat cable, and an auto lock unit locking a rotor automatically in such a manner that at a neutral position of the clock spring, where a first locking groove of the rolling plate and a second locking groove of a stator, defining the internal space of the clock spring, overlap with each other, wherein the auto lock unit engages with the first and second overlapping locking grooves to lock the rotor.

### CROSS-REFERENCE TO RELATED APPLICATION

This application claims under 35 U.S.C. §119(a) the benefit of Korean Application No. 10-2010-0068176 filed Jul. 14, 2011, the entire contents of which are incorporated herein by reference.

### BACKGROUND OF THE INVENTION

(a) Field of the Invention

The present invention relates, in general, to an auto lock mechanism of a clock spring for a vehicle and, more particularly, to an auto lock mechanism of a clock spring for a vehicle which is capable of locking at its neutral position a rotating body such as a rotor in a stationary body such as a stator.

(b) Description of the Related Art

Generally, steering wheels for a vehicle are provided with an airbag module, a horn switch and other electronic devices which are connected to a wire harness for supplying electric power.

Since such a steering wheel always operates to turn when steering, and if these components are wired simply using a general wire harness, as time goes by, the wire harness twists off, short-circuits form, and the contacts become separated, resulting in interruption of the functioning of the airbag, horn, or other electronic devices.

Therefore, a clock spring is provided such that when the steering wheel turns, a short circuit, a connection error, or the like does not occur on the wire harness because of it twisting and coming off.

The clock spring is a rotary connector which has a flat cable connecting a stationary body (a stator) and a rotating body (a rotor) rotatably mounted thereto and is mounted on a steering wheel to form an electrical connection with an airbag or the like.

That is, the clock spring serves to keep the wired connection of a variety of peripheral devices mounted thereto stable even when the steering wheel is turned to be operated.

Since a stationary body, such as a stator, is fastened and fixed to a steering column in the side of a vehicle body and the rotating body such as the rotor rotates together with the steering wheel and a shaft of the steering column, in a state of the clock spring being fitted into the steering column, the most important thing is that the clock spring always stably and reliably supplies external power to the steering wheel.

When the clock spring and the steering wheel have to be disassembled and then re-assembled because the clock spring or the steering wheel has to be replaced, etc., in order to prevent the flat cable of the clock spring from being over-wound around and disconnected at a connecting point or twisting off when the steering wheel is manipulated and turned, they have to be assembled such that the flat cable is properly wound around to an extent sufficient to cope with the degree of turning the steering wheel.

The neutral position of the clock spring has to be therefore precisely aligned. To this end, an operator should adjust the neutral position by precisely rotating the clock spring by a predetermined number of turns. For example, as noted in an assembly specification, the clock spring may be set to a neutral position by e.g. winding it all the way around to the right or left and then winding it three times to the left.

Moreover, if the upper plate of the clock spring and the upper surface of a sub-stator are marked with matching marks, and when the clock spring is re-mounted after being disconnected, the clock spring can be assembled while the flat cable is properly wound by matching up the two matching marks.

However, precisely matching up the neutral position of the clock spring requires the operator to pay careful attention to the number of turns made when performing the matching work because the marks may line up with each other even when the clock spring has not been turned the predetermined number of times.

This case of improper assembly may cause a problem of wire-twisting or the like.

To solve this problem conventional auto lock structures were adapted to the clock spring instead of introducing the matching marks. This conventional auto lock structure will be described with reference to FIG. 1.

As shown in the figure, the clock spring 100 includes a sub-stator 110 which defines a receiving space for a flat cable, protecting the internal parts, a rotor 120 which rotates together with the steering wheel, a stator 130 which is integrally assembled with the sub-stator 110 such that it forms a housing fixed to the vehicle side of a steering column, a sleeve 140 which has a cam shape for auto canceling and rotates together with the rotor 120, a flat cable (not shown) that is a cable for connection with an external power source and which is rotatably received in the receiving space while it is connected to a terminal, and a terminal mold block 160 in which a rotor-side terminal, to which the flat cable is connected, is inserted and assembled with the rotor 120.

Further, an auto lock 170 is assembled to the rotor 120. The auto lock 170 is provided in the rotor to operate responsively. When the auto lock moves to a position corresponding to a groove (not shown) of the stator 130, it engages with it so as to lock the rotor of a rotating body, the stator 130 of a stationary body, the sub-stator, and the like.

Since the clock spring 100 cannot rotate when the rotor 110 and the stationary body (i.e. the stator and the sub-stator) are locked together, the steering wheel is assembled and fixed to a neutral position when these two bodies are locked together. When fastening the steering wheel, the locked state has to be automatically unlocked and to this end, it is configured such that when an armature of the steering wheel pushes a press part of the auto lock 170, the auto lock 170 disengages from the groove of the stator 130, thereby automatically unlocking the locked state.

In this construction, locking and unlocking between the stator 130 and the rotor 120 is performed automatically by the auto lock 170, and particularly upon fastening the steering wheel, having to disconnect parts to fix them to a neutral position does not arise, so that improper assembly arising from deviation from a neutral position is prevented, and upon disconnection of the steering wheel at the neutral position, the clock spring 100 can be advantageously fixed to a neutral position automatically.

However, a problem also arises that whenever the auto lock 170 and the groove of the stator 130 correspond to each other for each turn of the clock spring 100, locking occurs even at the non-neutral position.

That is, while as noted in an assembly specification, the clock spring may be set to a neutral position by e.g. turning it fully to the right or left and then turning it two or three times, the auto lock 170 is locked at the same position for each turn, so that it cannot be checked whether the position is an exactly neutral position even though the clock spring 100 had not been rotated because it was locked before the steering wheel was not mounted.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, the present invention has been made keeping in mind the above problems occurring in the related art.

In one aspect, the present invention provides an auto lock mechanism of a clock spring for a vehicle which is capable of being locked at an exact neutral position of the clock spring. In one embodiment, the clock spring is capable of being locked once the clock spring is located at an exact neutral position in the whole range of turning, so that when a steering wheel is disconnected in order to be serviced, for example, and re-assembled in an unlocked state, if the locked position is identified by rotating the clock spring in either the right or left direction, the auto lock mechanism can be set to an exactly neutral position.

In order to achieve the above object, according to one aspect of the present invention, there is provided an auto lock mechanism of a clock spring for a vehicle comprising:

a rolling plate provided in an internal space of the clock spring such that the rolling plate is rotated by a flat cable; and

an auto lock unit locking a rotor automatically in such a manner that at a neutral position of the clock spring where a first locking groove of the rolling plate and a second locking groove of a stator, defining the internal space of the clock spring, overlap with each other, the auto lock unit engages with the first and second overlapping locking grooves to lock the rotor.

In another embodiment, the auto lock unit may comprise:

a release lever rotatably hinge-coupled to the rotor to release a neutral state;

an auto lock pin rotatably connected to one end of the release lever which is capable of being locked or unlocked by engaging with or disengaging it from the first and second overlapping locking grooves according to a rotating direction of the release lever; and

a spring provided in a mounting groove of the rotor to resiliently move the auto lock pin between a locked position and an unlocked position.

In another embodiment, the release lever may have at the other end a press part that extends inwards from an inner circumference of the rotor, wherein when the press part rotates while being pushed by a steering wheel, and wherein the press part moves the auto lock pin to the unlocked position.

In yet another embodiment, the spring may have an elastic restoration force exerted to move the auto lock pin to the locked position.

In still another embodiment, the auto lock pin may comprise:

a spring-coupling pin part that is provided in one side such that the spring-coupling pain part is coupled with the spring, and

a locking pin part that is provided in another side such that the locking pin part engages with or disengages from the first and second overlapping locking grooves.

In still yet another embodiment, the spring-coupling pin part may comprise a spring support end that protrudes and is supported by the spring.

In another embodiment, the spring-coupling pin part may make contact with and be supported by one end of the release lever such that one end of the release lever, slides along the spring-coupling pin part, when the auto lock pin moves between the locked position and the unlocked position.

According to the construction of the embodiment, in a state of the first locking groove of the rolling plate overlapping with the second locking groove of the stator (i.e. at a neutral state of the clock spring), the auto lock unit engages with and disengages from the first and second locking grooves automatically, so that it can be locked in just one time at a neutral position of the clock spring over the entire turning range of the clock spring. Thus, for example, when a steering wheel is disconnected in order to be serviced and then re-assembled in an unlocked state, if the locked position is identified by rotating the clock spring in either the right or left direction, the auto lock mechanism can be set to an exactly neutral position.

### BRIEF DESCRIPTION OF THE DRAWINGS

The above and other objects, features and advantages of the present invention will be more clearly understood from the following detailed description when taken in to conjunction with the accompanying drawings, in which:

FIG. 1 is a perspective view of an assembled clock spring having a conventional auto lock structure;

FIG. 2 is a perspective view of a clock spring having an auto lock mechanism according to the invention;

FIG. 3 is an exploded perspective view of a clock spring and an auto lock mechanism according to the invention;

FIG. 4 is a cross-sectional view of a clock spring having an auto lock mechanism according to the invention;

FIGS. 5A and 5B are cross-sectional views taken along line A-A of FIG. 2; and

FIG. 6 is a view of grooves of a rolling plate and stator in an auto lock mechanism according to the invention.

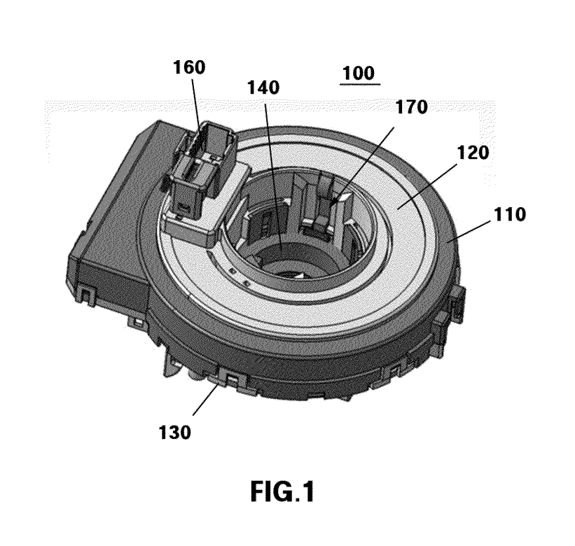

### DETAILED DESCRIPTION OF THE INVENTION

Reference will now be made in greater detail to embodiments of the invention, an example of which is illustrated in the accompanying drawings. Wherever possible, the same reference numerals will be used throughout the drawings and the description to refer to the same or like parts.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

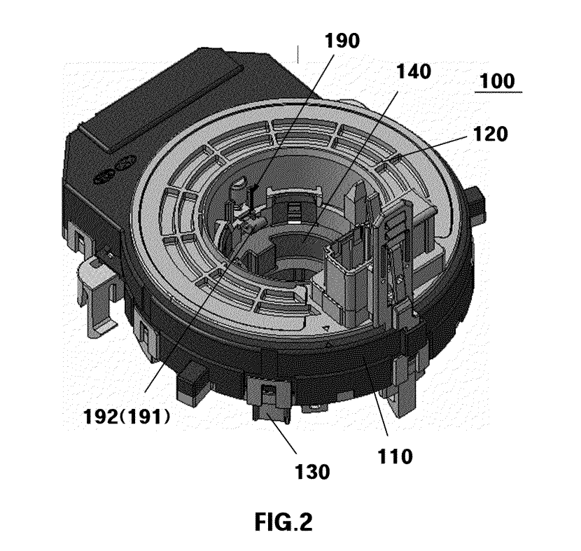

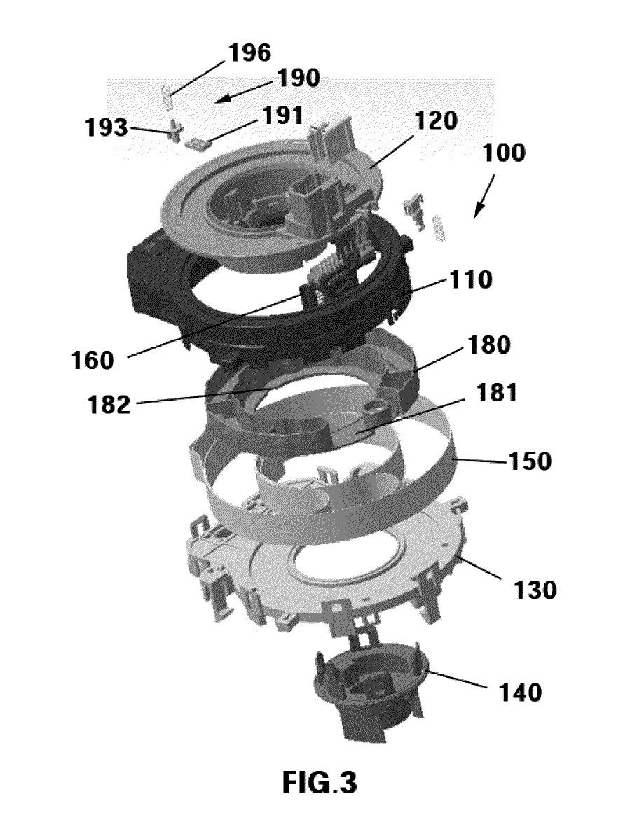

FIG. 2 is a perspective view of a clock spring having an auto lock mechanism according to the invention, and FIG. 3 is an exploded perspective view of a clock spring and an auto lock mechanism according to the invention.

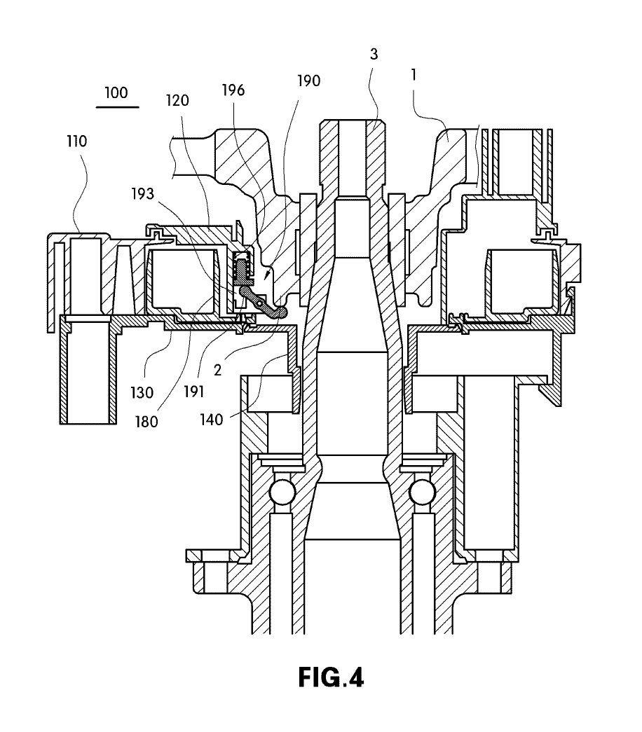

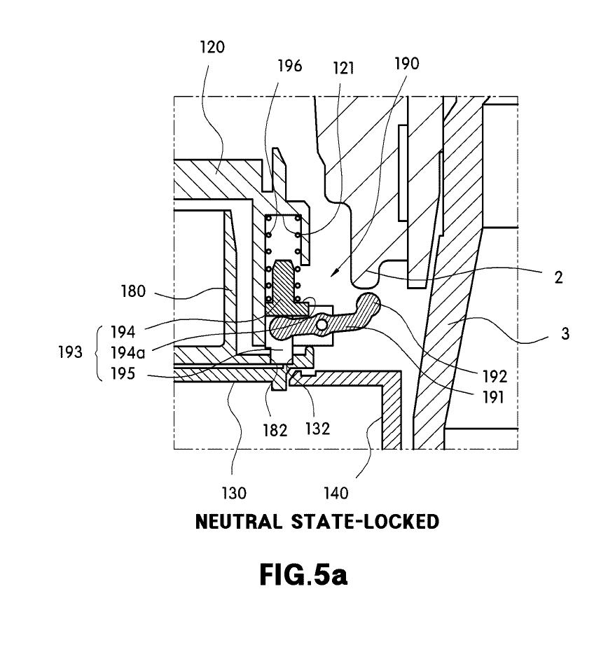

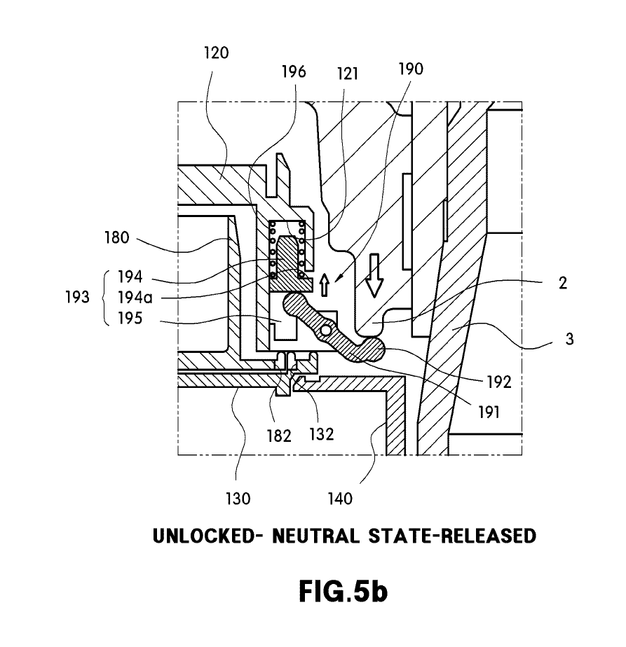

FIG. 4 is a cross-sectional view of a clock spring having an auto lock mechanism according to the invention, and FIGS. 5A and 5B are cross-sectional views taken along line A-A of FIG. 2 and show the operation state of the auto lock mechanism.

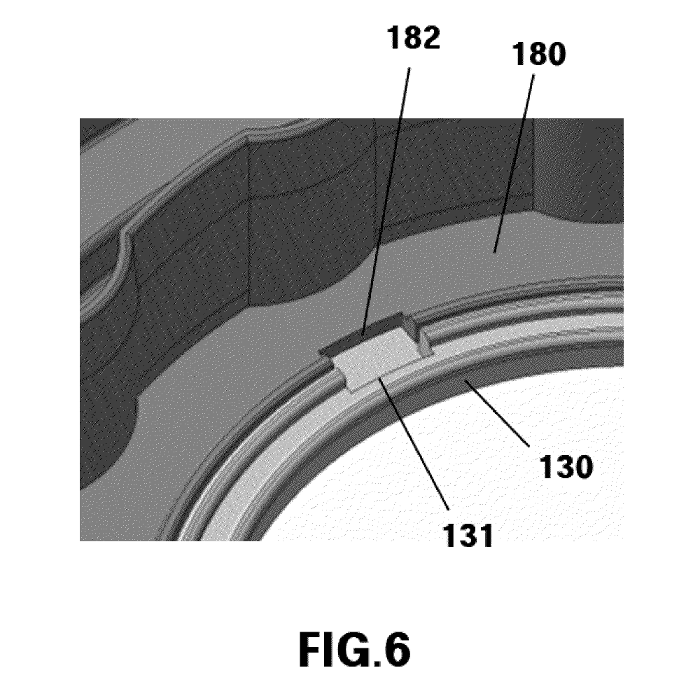

FIG. 6 is a view of grooves of a rolling plate and stator in an auto lock mechanism according to the invention, wherein the grooves overlap with each other at a neutral position of the clock spring.

The present disclosure relates to an auto lock mechanism of a clock spring 100 for a vehicle, which is capable of being locked at an neutral position of the clock spring 100. In certain embodiments the auto lock mechanism may only be locked at exactly a neutral position.

That is, in certain embodiments, the auto lock mechanism may be locked once at an exactly neutral position of the clock spring 100 over the entire turning range. In certain embodiments, the auto lock mechanism is configured so that when a steering wheel 1 is disconnected in order to be serviced, for example, and re-assembled in an unlocked state, if the locked position is identified by rotating the clock spring 100 in either the right or left direction, the auto lock mechanism can be set to an exactly neutral position.

Thus, although the clock spring rotates 360°, if it is not at a neutral position, locking does not occur, so that when the rotor of the clock spring does not rotate and becomes locked before the steering wheel is mounted, that position is determined as a to neutral position and then the steering wheel can be mounted.

Further, if the steering wheel is pushed down to a fastening position, the locked state of the clock spring is unlocked automatically so that the steering wheel fastened to the clock spring can be manipulated and rotated. The construction of the auto lock mechanism will now be described in detail.

First, as shown in FIG. 3, the clock spring 100 comprises a sub-stator 110 which defines a receiving space for a flat cable 150, protecting internal parts, a rotor 120 which is assembled to rotate together with the steering wheel 1, a stator 130 which is integrally assembled with the sub-stator 110 such that it forms a housing fixed to the vehicle body side of a steering column, a sleeve 140 which has a cam shape for auto canceling and is assembled to rotate together with the rotor 120, a flat cable 150 that is a cable providing connection with an external power source and which is rotatably received in the receiving space while it is connected to a terminal, and a terminal mold block 160 in which a rotor-side terminal, to which the flat cable is connected, is inserted and assembled with the rotor 120.

In this construction, the auto lock mechanism comprises an auto lock unit 190 locking a rotor 120 automatically in such a manner that at a neutral position of the clock spring 100 where a first locking groove 182 of a rolling plate 180, which is provided in an internal space of the clock spring 100 such that the rolling plate rotates by a flat cable 150, and a second locking groove 131 of a stator 130, defining the internal space of the clock spring 100, overlap with each other, the auto lock unit automatically engages with the first and second overlapping locking grooves 182 and 131 to lock the rotor 120.

That is, the rolling plate 180 is further provided to rotate together with the flat cable 150 while being coupled thereto. The flat cable 150 is positioned such that a portion of an inner side of the flat cable 150 is connected to the inside of the rolling plate 180 and a portion of an outer side of the flat cable 150 is connected to the outside through an opening 181 formed on one side of the rolling plate 180.

The rolling plate keeps the flat cable 150 in a not-entangled state, and also guides the flat cable 150 to the outside through the opening 181.

Further, the rolling plate 180 rotates in the same direction as the direction in which the flat cable 150 is being rotated, and the rolling plate 180 and the flat cable 150 are received in the internal space defined by the sub-stator 110 and the stator 130, in a state of being assembled such that they move together.

In certain embodiments, the rolling plate 180 has the first locking groove 182 in an inner circumference of the lower portion. In a neutral state of the clock spring 100, the first locking groove 182 of the rolling plate 180 coupled with the flat cable 150 overlaps with the second locking groove 131 formed in the stator 130.

That is, the clock spring 100 is assembled such that in a neutral state, the second locking groove 131 of the stator 130 and the first locking groove 182 of the rolling plate 180 overlap with each other. FIG. 6 illustrates such a neutral state in which the two locking grooves 131 and 182 overlap with each other.

As such, if the first locking groove 182 of the rolling plate 180 and the second locking groove 131 of the stator 130 overlap with each other, the neutral state is obtained, and in this case, auto locking is carried out.

The two locking grooves overlap once over the entire range of their turning because rotating speeds of the rotor 120 and the rolling plate 180 are different from each other. This is because when the rotor 120 is rotated by the steering wheel 1, the rolling plate 180 is rotated by the flat cable 150.

Meanwhile, the auto lock unit 190 is provided to lock the two locking grooves automatically in a state of the two locking grooves 131 and 182 overlapping with each other. The auto lock unit 190, as shown in FIGS. 2 to 5B, is mounted to the rotor 120 such that it rotates together with the rotor.

The auto lock unit 190 includes a release lever 191 rotatably hinge-coupled to the lower portion of the rotor 120 to release a neutral state, an auto lock pin 193 rotatably connected to one end of the release lever 191 and designed to be locked or unlocked by engaging with or disengaging from the first and second overlapping locking grooves 182 and 131 according to a rotating direction of the release lever 191, and a spring 196 provided to resiliently move the auto lock pin 193 between a locked position and an unlocked position.

The release lever 191 is configured so that a first end is inserted into a spring-mounting groove 121 of the rotor 120, and a second end extends inwards from the inner circumference of the rotor 120. The second end is a press part 192 that contacts and is pushed by an end of an armature 2 of the steering wheel 1.

The auto lock pin 193 has a spring-coupling pin part 194 that is provided in one side such that the spring-coupling pain part is coupled with the spring 196, and a locking pin part 195 that is provided in another side such that the locking pin part engages with or disengages from the first and second overlapping locking grooves 182 and 131.

The spring-coupling pin part 194 protrudes upwards and the locking pin part 195 protrudes downwards, the spring 196 (e.g. a coil spring) is mounted between a spring support end 194a that protrudes from the lower portion of the spring-coupling pin part 194 and an inner side of the spring-mounting groove 121.

The spring-coupling pin part 194 of the auto lock pin 193 contacts and is supported at the lower portion by one end of the release lever 191 such that one end of the release lever 191, which rotates when the auto lock pin 193 vertically moves between the locked position and the unlocked position, slides along the lower portion of the spring-coupling pin part 194.

The spring 196 is vertically mounted in the spring-mounting groove 121 of the rotor 120 such that it resiliently supports the spring support end 194a. Particularly, the spring force is exerted in a direction in which the locking pin part 195 of the auto lock pin 193 is inserted into the first and second overlapping locking grooves 182 and 131.

That is, the spring force acts in the direction of pushing and moving the auto lock pin 193 downwards to an unlocked position. When the locking pin part 195 of the auto lock pin 193 is inserted into the two overlapping locking grooves 131 and 182 by the spring force, the auto lock mechanism is maintained in the locked state. Further, the two locking grooves 131 and 182 overlap each other at a neutral state of the clock spring, so that the neutral state of the clock spring 100 can be maintained by the spring 196.

FIGS. 4, 5A and 5B describe an auto lock mechanism being locked and unlocked at the neutral state. FIGS. 4, 5A and 5B are described in further detail below.

First, at the neutral state where the two locking grooves 131 and 182 overlap each other, the auto lock pin 193 mounted in the rotor 120 is pushed down by the spring force, i.e. the elastic restoration force of the spring 196 that is compressed, so that the locking pin part 195 is inserted into all of the locking grooves at the same time. Thus, the rotor 120, the rolling plate 180, and the stator 130 become locked by the locking pin part 195, thereby stopping the clock spring 100 (i.e. the rotor) from rotating.

At the same time, the release lever 191 rotates in a counter-clockwise direction as viewed in the drawings, and the press part 192 moves upwards.

Then, when the steering wheel 1 is mounted on the column shaft 3, the armature 2 of the steering wheel 1 moves down and presses the press part 192 of the release lever 191 of the rotor 120, so that the release lever 191 rotates in a clockwise direction as viewed in the drawing.

Here, the auto lock pin 193 generally moves upwards while re-compressing the spring 196, so that in the neutral state, the locking pin part 195 disengages from the two overlapping locking grooves 131 and 182, and is put into the unlocked state.

Therefore, when the two locking grooves 131 and 182 are overlapped with each other by rotating the rotor 120 of the clock spring 100 in any direction, in the neutral state, the auto lock pin 193 moves down because of the elastic restoration force of the spring 196 and automatically becomes locked. Further, when the steering wheel 1 is mounted in the locked state of the neutral state, the armature 2 pushes down the press part 192 of the release lever 191, so that the release lever 191 rotates and the auto lock pin 193 moves upwards, automatically unlocking and releasing the neutral state.

Although certain embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An auto lock mechanism of a clock spring for a vehicle comprising:
a rolling plate provided in an internal space of the clock spring such that the rolling plate is rotated by a flat cable; and
an auto lock unit locking a rotor automatically in such a manner that at a neutral position of the clock spring where a first locking groove of the rolling plate and a second locking groove of a stator, defining the internal space of the clock spring, overlap with each other,
wherein the auto lock unit engages with the first and second overlapping locking grooves to lock the rotor.

2. The auto lock mechanism according to claim 1, wherein the auto lock unit comprises:
a release lever rotatably hinge-coupled to the rotor to release a neutral state;
an auto lock pin rotatably connected to one end of the release lever which is capable of being locked or unlocked by engaging with or disengaging from the first and second overlapping locking grooves according to a rotating direction of the release lever; and
a spring provided in a mounting groove of the rotor to resiliently move the auto lock pin between a locked position and an unlocked position.

3. The auto lock mechanism according to claim 2, wherein the release lever has at the other end a press part that extends inwards from an inner circumference of the rotor, wherein when the press part rotates while being pushed by a steering wheel, and wherein the press part moves the auto lock pin to the unlocked position.

4. The auto lock mechanism according to claim 2, wherein the spring exerts an elastic restoration force to move the auto lock pin to the locked position.

5. The auto lock mechanism according to claim 2, wherein the auto lock pin comprises:
a spring-coupling pin part that is provided on one side such that the spring-coupling pain part is coupled with the spring, and
a locking pin part that is provided on another side such that the locking pin part engages with or disengages from the first and second overlapping locking grooves.

6. The auto lock mechanism according to claim 5, wherein the spring-coupling pin part comprises a spring support end that protrudes and is supported by the spring.

7. The auto lock mechanism according to claim 6, wherein the spring-coupling pin part makes contact with and is supported by one end of the release lever such that one end of the release lever, slides along the spring-coupling pin part when the auto lock pin moves between the locked position and the unlocked position.
